(19) United States
(12) Patent Application Publication
(10) Pub. No.: US 2010/0236232 A1
(43) Pub. Date: Sep. 23, 2010

(54) Drive for a Hydraulic Excavator

(75) Inventors: Daniel Boehm, Bergholtz (FR); Thomas Landmann, Eguisheim (FR); Ralf Spãth, Breisach (DE)

Correspondence Address: DILWORTH & BARRESE, LLP, 1000 WOODBURY ROAD, SUITE 405, WOODBURY, NY, 11797, US

(73) Assignee: LIEBHERR FRANCE SAS, Colmar Cedex (FR)

(21) Appl. No.: 12/728,660

(22) Filed: Mar. 22, 2010

(30) Foreign Application Priority Data
Mar. 23, 2009 (DE) UM202009004071.2

(51) Int. Cl. F15B 1/027

(52) U.S. Cl. 60/413

(57) ABSTRACT

The present invention relates to a drive for an excavator with a number of individual drives, such as a slewing gear drive, a hoist drive, a bucket drive and an arm drive, wherein for the slewing gear drive two reversible adjusting units are provided, which are at least coupled with an energy accumulator.

### BACKGROUND OF THE INVENTION

This invention relates to a drive for a construction machine, in particular for an excavator with a number of individual drives, such as at least one rotatory drive, e.g. a slewing gear drive, and at least one linear drive, e.g. a hoist drive, a bucket drive and/or an arm drive.

From DE 103 43 016 A1 it is known already to actuate a double-acting hydraulic cylinder by means of two hydraulic pumps. One of the two hydraulic pumps is connected with the two working chambers of the double-acting hydraulic cylinder in a closed circuit. The second hydraulic pump, on the other hand, only is connected with the piston-side working chamber in an open circuit. The two hydraulic pumps each have a variable displacement. By adjusting a corresponding displacement ratio over the different volume flow in the piston-side working chamber, the working chamber on the piston rod side is taken into account.

From DE 10 2007 025 742 A1, a hydrostatic drive with a first hydraulic pump and a second hydraulic pump and with a double-acting hydraulic cylinder is known, wherein the drive comprises an extraction valve for extracting pressure medium from a pressure medium reservoir with a first flow direction of the hydraulic pumps.

Hydrostatic drives are used for example for driving hydraulic excavators. As drive unit, a Diesel engine is used in general, which serves as drive element for the hydraulic actuators. The hydraulic actuators are individual drives, such as the traveling drive, the slewing gear drive and the hoist drive, bucket drive and arm drive consisting of double-acting hydraulic cylinders. Via the hoist drive for example the complete equipment of the machine is actuated. The potential energy of the equipment is changed with every hoisting or lowering movement. During the hoisting movement, energy must be introduced into the system, whereas during the lowering movement this energy is released again. In known systems, the energy released simply is destroyed during the lowering movement of the hoisting equipment. This is accomplished by correspondingly throttling the return flow of the hoisting cylinders in the control piston. Since the weight of the equipment represents a multiple of the charge in the bucket, a considerable amount of energy is destroyed here.

### SUMMARY OF THE INVENTION

It is the object of the invention to develop a drive for an excavator known per se such that a rather large part of the drive energy can be recovered and is available for further drive movements.

In accordance with the invention, this object is solved by the combination of the features herein.

Accordingly, in a generic drive for an excavator with a number of individual drives, such as a stewing gear drive, a hoist drive, a bucket drive and an arm drive, the closed circuit for the stewing gear drive is formed of two reversible adjusting units which are at least coupled with an energy accumulator.

In principle, it is known already that a slewing gear of an excavator is operated in a closed circuit. In known hydraulic excavators, however, the one reversible adjusting unit is an adjustable hydraulic pump, whereas the associated hydraulic motor is rigid, so that the high-pressure side and the low-pressure side alternate with the direction of rotation of the uppercarriage.

In accordance with the present invention, on the other hand, in which the hydraulic units both are hydraulic, reversible adjusting units, both elements are operable both as pump and as motor. Thus, as far as the reversible adjusting units here constitute hydraulic components, one side of the closed circuit between the two reversible adjusting means and a first accumulator can be under high pressure, whereas the other side of the closed circuit always is under low pressure, in contrast to the aforementioned prior art.

Upon actuation of the slewing gear, braking energy is passed on for storage from the one adjusting unit for the case of slowing down the uppercarriage of the excavator. If necessary, this energy can also be passed on via the second reversible adjusting unit to further units, such as pumps, which can be coupled with the second adjusting unit.

In the accumulator, the braking energy of the uppercarriage now is stored, in order to be used again during the next acceleration. This energy then is supplied to the reversible adjusting unit serving as slewing gear motor. If necessary, however, the energy stored in the accumulator can also be supplied to the other reversible adjusting unit, by means of which for example the working hydraulics of further connected systems such as the hoisting gear etc. is supported.

Advantageous aspects of the invention can be taken from the sub-claims following the main claim.

Thus, at least one of the reversible adjusting units can be connectable with the drive unit of the excavator, for example the Diesel engine. Since the charging and discharging operations have a certain efficiency, the energy accumulator can correspondingly be recharged via this drive unit.

The reversible adjusting units advantageously are hydraulic adjusting units, which can reverse the flow direction with the same sense of rotation, so that they can operate as motor or pump. The at least one accumulator advantageously is a hydraulic accumulator.

Particularly advantageously, a second hydraulic accumulator can be provided for compensation of the hydraulic oil withdrawn from or fed back to the other hydraulic accumulator. This second hydraulic accumulator preferably is connected on the low-pressure side of the closed hydraulic circuit.

Particularly advantageously, the adjusting units of the slewing gear drive can energetically be coupled with the adjusting units of the hoisting gear drive. This provides for shifting energy from one drive circuit to the other. The entire control advantageously can be effected via an electronic energy management controller.

In accordance with an alternative variant, the reversible adjusting units can, however, also consist of electrical adjusting units, which each consist of an electrical unit with a voltage transformer. In this case, the accumulator advantageously is an electric accumulator, for example a battery or a supercapacitor (ultracaps).

Advantageously, an additional voltage transformer can be present, via which further electric drives, such as drives for cooling fans, air-conditioning compressors, water pumps or the like, can be supplied with electricity.

In accordance with a particularly preferred aspect of the invention, at least one hoisting cylinder is provided, which is connected with two hydraulic adjusting units. The two hydraulic adjusting units can be connectable with one of the reversible adjusting units of the slewing gear drive.

Preferably, one of the hydraulic adjusting units can also be connected with a hydraulic accumulator.

### BRIEF DESCRIPTION OF THE DRAWINGS

Further details, features and advantages of the invention will be explained in detail with reference to an embodiment illustrated in the drawing, in which:

FIG. 1: shows a schematic representation of the drive in accordance with a first variant of the invention;

FIG. 2: shows a schematic representation of an alternative drive; and

FIG. 3: shows a schematic representation of a further alternative drive.

### DESCRIPTION OF THE PREFERRED EMBODIMENTS

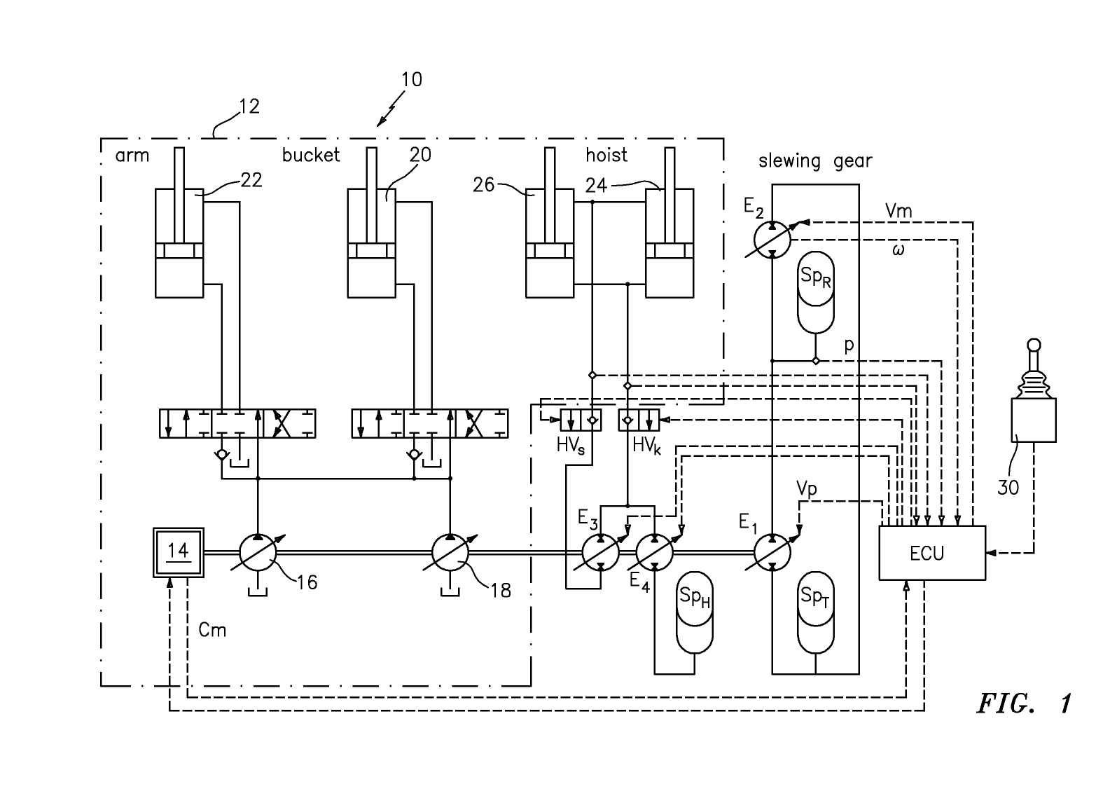

In FIG. 1, the circuit diagram of a drive of the invention is shown, in which a number of individual drives are driven hydraulically. The individual drives on the one hand include the drive for a dipper arm, for a bucket, for the hoisting cylinder and for the stewing gear. Within the dash-dotted line 12, the individual components of a known hydraulic drive for a hydraulic excavator (not shown here in detail) are represented. First of all, a schematically represented drive unit 14 is provided here, which usually is a Diesel engine. Via the Diesel engine, hydraulic pumps 16 and 18 are driven, which supply corresponding double-acting hydraulic cylinders 20 and 22 with hydraulic oil. The double-acting hydraulic cylinder 20 is the drive cylinder for the non-illustrated bucket of the excavator. The double-acting hydraulic cylinder 22 is the drive cylinder for the likewise non-illustrated dipper arm. Beside the double-acting hydraulic cylinders 20 and 22, two double-acting hydraulic cylinders 24 and 26 furthermore are provided, which as hoisting cylinders actuate the hoist and the lowering movement of the entire equipment of the hydraulic excavator not shown here in detail. Both the drive of the hoisting cylinders 24 and 26 and the drive of the likewise non-illustrated slewing gear are newly designed in the variant of the invention which is explained here in detail. The drive components of the stewing gear each consist of hydraulically reversible adjusting units E₂ and E₁, which actuate the stewing gear in the closed circuit. In accordance with the present invention, these hydraulically reversible adjusting units can reverse the flow direction with the same sense of rotation, so that the adjusting units E₂ and E₁ can operate both as pump and as motor. On one side of the closed circuit between the adjusting units E₂ and E₁ high pressure exists. To the connecting line on this high-pressure side a hydraulic accumulator Sp_{R} is connected, which serves as energy accumulator. As required, this hydraulic accumulator Sp_{R} can be charged or discharged by the adjusting unit E₂ or E₁. On charging, energy is charged into the accumulator, and on discharging the stored energy is again returned to the corresponding unit.

On the low-pressure side of the closed circuit, a further accumulator Sp_{T} is provided in the line between the adjusting unit E₂ and E₁, which can be regarded as tank. It compensates the hydraulic volume which on the high-pressure side is withdrawn from accumulator Sp_{R} of the hydraulic circuit or is fed back into the same. This means that the oil volume withdrawn on the one side of the hydraulic circuit is fed in again on the other side and vice versa.

The hoisting cylinders 24 and 26 are directly connected with hydraulic adjusting units E₃ and E₄. To prevent the load held by the hoisting cylinders 24 and 26 from slowly decreasing via leakages in the hydraulic adjusting units E₃ and E₄, two load-holding valves HV_{K} and HV_{S} are incorporated. The same are correspondingly controlled to open during the usual working movement, so that the oil flow is not impeded. On the opposite side of the connection to the hydraulic cylinders 24 and 26, the hydraulic unit E₄ is connected with a further accumulator Sp_{H}. This is also a hydraulic accumulator. The use of the accumulator Sp_{H} offers the advantages that the hydraulic unit E₄ can be reduced in size and that the efficiency of the energy storage on the whole can be improved.

The hydraulic adjusting units E₃ and E₄ are coupled with the hydraulically reversible adjusting unit E₁ of the slewing gear drive in the manner shown in FIG. 1.

The entire control of the drive is effected via the electronic control unit ECU, which performs the electronic energy management. The broken lines indicate the respective signal lines of the controller. The controller ECU receives the pilot control commands of the pilot control 30, via which the respective operating commands for the hoisting gear and the slewing gear can be entered by the excavator operator.

The mode of operation of the different drives during operation in accordance with the invention is set forth below. Via the slewing gear, the excavator uppercarriage is moved with respect to the excavator undercarriage. When slowing down the excavator uppercarriage, braking energy flows from the adjusting unit E₂ to the accumulator Sp_{R} and if necessary also to the hydraulically reversible adjusting unit E₁ acting as hydraulic motor, via which for example the hydraulic pumps E₃ and E₄ can be driven.

In the accumulator Sp_{R}, the braking energy of the uppercarriage is stored, in order to be used again during the next accelaration. This energy then again flows to the hydraulically reversible adjusting unit E₂ which this time serves as slewing gear motor or, if necessary, also to the hydraulically reversible adjusting unit E₁, via which the working hydraulics can be supported.

Since the charging and discharging operations of the accumulators now each have a certain efficiency, the respective accumulator must be recharged via the drive unit 14 in the case of a corresponding decrease of the accumulator pressure. This is accomplished via the adjusting unit E₁ after a corresponding actuation by the controller ECU.

When lowering the equipment, i.e. on retraction, the hoisting cylinders 24 and 26 can feed the potential energy of the equipment via the adjusting units E₃ and E₄ into the accumulator Sp_{H} and in addition via the hydraulically reversible adjusting unit E₁ into the accumulator Sp_{R}. The hydraulic units E₃, E₄ and E₁ each form a hydraulic transformer, so that the necessary pressure reductions between the hydraulic cylinders 24 and 26 and the hydraulic accumulators Sp_{H} and Sp_{R} take place almost loss-free. Furthermore, this solution provides for a free lowering speed, which only is influenced by the excavator operator. If necessary, additional energy can be supplied from the drive unit 14 into the accumulators Sp_{H} and Sp_{R} for maintaining the energy level and for a better utilization of the drive motor.

When lifting the equipment or extending the hydraulic cylinders, stored energy now is again supplied from the hydraulic accumulators Sp_{H} and Sp_{R} via the hydraulic units E₁, E₃ and E₄ to the double-acting hydraulic cylinders 24, 26. Parallel thereto, additional energy from the drive unit 14 can be added, so that this movement no longer is limited in its speed by the installed engine power. In this way, the solution of the invention as presented here not only provides for an energy recovery or energy savings, but also for a better machine dynamics of the excavator used. As compared to usual series-produced machines, the hoisting movement is accelerated many times over.

The electronic control unit ECU advantageously consists of a plurality of modules and detects the different signals of the drive, processes the same and finally controls the different adjusting members; such as the pump adjustment or the sliding valves, correspondingly.

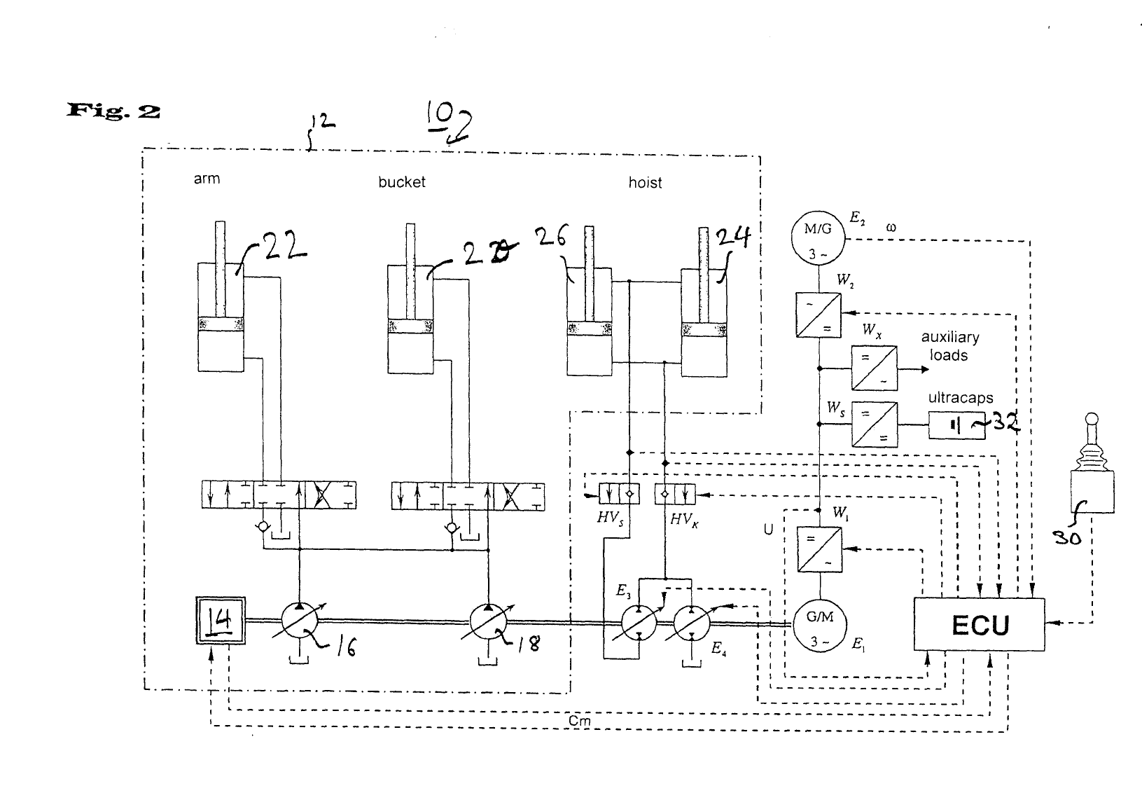

In FIG. 2, a further variant of the invention is shown. In contrast to FIG. 1, an electrical solution of the slewing gear drive is realized here. The mode of operation of this drive largely corresponds to that in accordance with the embodiment of FIG. 1, so that as far as the total effect and the remaining structure is concerned, reference can be made to the previous description. In the present case, however, the hydraulic units E₁ and E₂ represented in the embodiment of FIG. 1 are electrical units, which likewise act as reversible units and in the present case as electric motor or generator. To the respective reversible units E₂ and E₁ voltage transformers W₂ and W₁ are associated. Instead of the hydraulic accumulator Sp_{R} in FIG. 1, an electric accumulator in the form of a battery or a supercapacitor (ultracaps) is used here in conjunction with a voltage transformer Wₛ. When using supercapacitors, the voltage transformer Wₛ provided in the illustrated variant of FIG. 2 need not necessarily be present.

In the electrical solution of FIG. 2, auxiliary loads can be connected in addition via corresponding voltage transformers Wₓ. These can be electrified auxiliary loads, for example the electric drive of a cooling fan, the electric drive of an air-conditioning compressor and the electric drive of water pumps. In the schematic diagram of FIG. 2, the loads are not shown in detail. The reversible adjusting units E₃ and E₄, which are connected with the hoisting cylinders 24 and 26, likewise are present in the variant of FIG. 2. In this embodiment, however, the reversible adjusting unit E₄ is not connected with a hydraulic accumulator Sp_{H}, but with a hydraulic oil sump.

The mode of operation of the drive in accordance with the variant of FIG. 2 resembles that in accordance with the pure hydraulic solution of FIG. 1. However, there is the difference that the energy of the slewing gear and of the hoist is stored only in the one electric accumulator unit 32 (ultracaps, battery). Thus, the hydraulic accumulators Sp_{H} and Sp_{R} of the hydraulic solution of FIG. 1 are replaced here by this one electric accumulator 32.

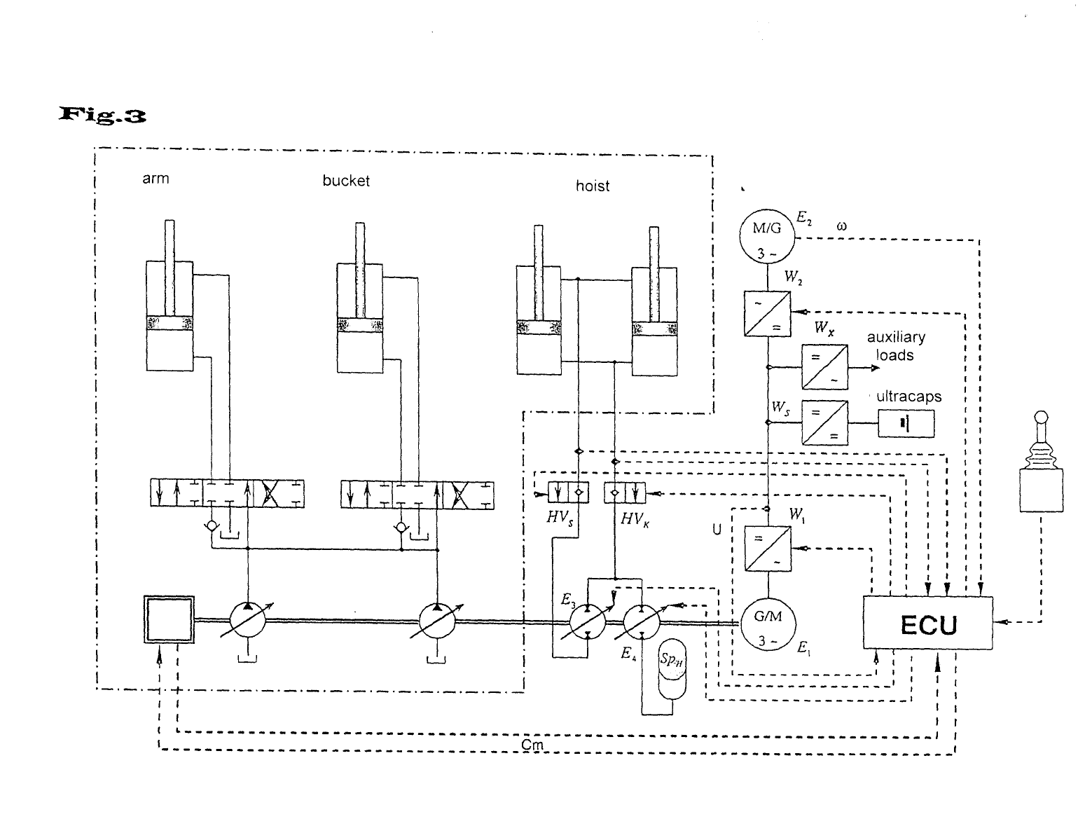

Finally, FIG. 3 shows a third variant of the drive in accordance with the invention. Substantially, this is a drive which corresponds to the variant of FIG. 2, i.e. the “electrical solution”. Instead of a connection to a sump, a hydraulic accumulator Sp_{H} here is connected to the hydraulic adjusting unit E₄, as was the case already in a similar way in the “hydraulic solution” in accordance with the embodiment of FIG. 1. Accordingly, this is an “electrohydraulic” solution.

The use of the hydraulic accumulator Sp_{H} offers two advantages. On the one hand, the efficiency of the energy storage is improved. Finally, the size of the hydraulic unit E₄ is reduced.

1. A drive for an excavator with a number of individual drives, such as a slewing gear drive, a hoist drive, a bucket drive and an arm drive, wherein for the slewing gear drive two reversible adjusting units are provided, which are at least coupled with an energy accumulator.

2. The drive according to claim 1, wherein one of the reversible adjusting units is connectable with a drive unit of the excavator.

3. The drive according to claim 1, wherein the reversible adjusting units are hydraulic adjusting units, which can reverse the flow direction with the same sense of rotation, so that they can operate as motor or pump and that the at least one accumulator is a hydraulic accumulator.

4. The drive according to claim 3, wherein a second hydraulic accumulator is provided for compensation of the hydraulic oil withdrawn from or fed back to the other hydraulic accumulator.

5. The drive according to claim 4, wherein the hydraulic reversible adjusting units form a closed hydraulic circuit with the first hydraulic accumulator and the second hydraulic accumulator, in which the two hydraulic reversible adjusting units always are under high pressure on a side by which the first hydraulic accumulator also is connected, whereas on the other side, by which the second hydraulic accumulator is connected, they are always under low pressure.

6. The drive according to claim 1, wherein the adjusting units of the slewing gear drive are energetically coupled with the adjusting units of the hoisting gear drive.

7. The drive according to claim 1, wherein it can be controlled via an electronic energy management controller.

8. The drive according to claim 1, wherein the reversible units are electrical units, which are composed of an electrical unit with a voltage transformer.

9. The drive according to claim 8, wherein the accumulator is an electric accumulator.

10. The drive according to claim 8, wherein an additional voltage transformer is provided, via which the further electric drives, such as drives for cooling fans, air-conditioning compressors, water pumps or the like can be supplied with electricity.

11. The drive according to claim 1, wherein at least one hydraulic cylinder is present, which is connected with two hydraulic adjusting units.

12. The drive according to claim 11, wherein one of the adjusting units preferably is connected with a hydraulic accumulator.

13. The drive according to claim 11, wherein the two hydraulic adjusting units of the at least one hydraulic cylinder are connectable with one of the reversible adjusting units.

14. The drive according to claim 2, wherein the reversible adjusting units are hydraulic adjusting units, which can reverse the flow direction with the same sense of rotation, so that they can operate as motor or pump and that the at least one accumulator is a hydraulic accumulator.

15. The drive according to claim 14, wherein a second hydraulic accumulator is provided for compensation of the hydraulic oil withdrawn from or fed back to the other hydraulic accumulator.

16. The drive according to claim 15, wherein the hydraulic reversible adjusting units form a closed hydraulic circuit with the first hydraulic accumulator and the second hydraulic accumulator, in which the two hydraulic reversible adjusting units always are under high pressure on a side by which the first hydraulic accumulator also is connected, whereas on the other side, by which the second hydraulic accumulator is connected, they are always under low pressure.

17. The drive according to claim 16, wherein the adjusting units of the slewing gear drive are energetically coupled with the adjusting units of the hoisting gear drive.

18. The drive according to claim 15, wherein the adjusting units of the slewing gear drive are energetically coupled with the adjusting units of the hoisting gear drive.

19. The drive according to claim 14, wherein the adjusting units of the slewing gear drive are energetically coupled with the adjusting units of the hoisting gear drive.

20. The drive according to claim 5, wherein the adjusting units of the slewing gear drive are energetically coupled with the adjusting units of the hoisting gear drive.
